(19) United States
(12) Patent Application Publication
(10) Pub. No.: US 2016/0152842 A1
(43) Pub. Date: Jun. 2, 2016

(54) INSULATING LAYER-FORMING COMPOSITION AND USE THEREOF

(71) Applicant: Hilti Aktiengesellschaft, Schaan (LI)

(72) Inventor: Juliane Marauska, Augsburg (DE)

(21) Appl. No.: 15/017,080

(22) Filed: Feb. 5, 2016

Related U.S. Application Data
(63) Continuation of application No. PCT/EP2014/066353, filed on Jul. 30, 2014.

(30) Foreign Application Priority Data
Aug. 6, 2013 (EP) 13179404.2

(51) Int. Cl. C09D 5/18; C09D 183/04

(52) U.S. Cl. CPC C09D 5/185; C09D 183/04

(57) ABSTRACT

Described is an insulating layer-forming composition that comprises a binding agent, based on addition-crosslinking polyorganosiloxanes. The inventive composition having a rate of expansion that is relatively high allows coatings having the layer thickness required for the respective period of fire resistance to be applied in a simple and fast manner, while at the same time the layer thickness is reduced to a minimum and yet a high insulating effect can be achieved. The composition of the invention is particularly suitable for fire protection, in particular, as a coating of metallic and non-metallic substrates, for example, steel construction elements, such as columns, beams, truss members, in order to increase the period of fire resistance.

### RELATED APPLICATIONS

This application claims priority to, and is a continuation of, co-pending International Application No. PCT/EP2014/066353 having an International filing date of Jul. 30, 2014, which is incorporated herein by reference, and which claims priority to European Patent Application No. 13179404.2, having a filing date of Aug. 6, 2013, which is also incorporated herein by reference in its entirety.

### SUMMARY OF THE TECHNOLOGY

The present invention relates to a composition for the formation of an insulating layer, in particular, a composition that has intumescent properties and that contains a binding agent, based on addition crosslinking polyorganosiloxanes, and the use of such an insulating layer-forming composition for fire retardation, in particular, for coating construction elements, such as columns, beams, or truss members, in order to increase the period of fire resistance.

### BACKGROUND OF THE INVENTION

Compositions for the formation of an insulating layer, also referred to as intumescent compositions, are generally applied to the surface of construction elements, for the purpose of forming coatings, in order to protect these construction elements from fire or against the effect of extreme heat, for example, as a result of a fire. In the meantime steel constructions have become an integral part of modern architecture, even if they have a distinct disadvantage compared to reinforced concrete construction. At temperatures exceeding approximately 500 deg. C., the load bearing capacity of steel drops by 50%. That is, the steel loses its stability and load bearing capacity. This temperature can be reached, as a function of the fire load, for example, during direct exposure to fire (approximately 1,000 deg. C.), after about 5 to 10 minutes, a situation that often leads to a loss in the load bearing capacity of the structure. At the present time the goal of fire retardation, in particular, the fire retardation of steel, is to prolong as long as possible the time it takes for a steel construction to lose its load bearing capacity in the event of a fire for the purpose of saving human lives and valuable assets.

For this purpose the building regulations in many countries require commensurate periods of fire resistance for certain structures made of steel. These periods are defined by means of the so called F classes, such as F 30, F 60, F 90 (fire resistance classes in compliance with DIN 4102 2) or the American classes in compliance with ASTM etc. In this respect F 30 according to DIN 4102 2 means, for example, that in the event of a fire the load bearing steel construction has to be able to withstand the fire for at least 30 minutes under standard conditions. This requirement is usually met by slowing down the rate of the temperature rise of the steel, for example, by coating the steel construction with coatings that form an insulating layer. In this case it involves paints with constituents that foam to form a solid microporous carbon foam in the event of a fire. At the same time a fine pored and thick foam layer, the so called ash crust, forms. This foam layer has high heat insulating properties, as a function of the composition, and, as a result, slows down the temperature rise of the construction element, so that the critical temperature of approximately 500 deg. C. is reached no later than after 30, 60, 90, 120 minutes or up to 240 minutes. The decisive factor for the fire resistance that can be achieved is always the thickness of the layer of the coating applied or more specifically the ash crust that is produced by said coating that is applied. Closed profiles, such as pipes, with comparable solidity, require about twice the amount as compared to open profiles, such as beams with a double T profile. In order to satisfy the required periods of fire resistance, the coatings have to have a certain thickness and have to be able to form, when exposed to heat, an ash crust that is as voluminous as possible and, as a result, has good insulating properties and stays mechanically stable over the period of time that it is exposed to a fire.

To this end there exist a number of systems in the prior art. In essence a distinction is made between 100% systems and systems that are based on a solvent or water. In the solvent based systems or water based systems the binding agents, usually resins, are applied to the construction element as a solution, dispersion or an emulsion. These solvent based systems or water based systems can be designed as single component systems or as multi-component systems. Following application, the solvent or water evaporates and leaves behind a film that dries over time. Furthermore, a distinction may also be made between such systems, in which essentially the coating no longer changes during the drying phase, and such systems, in which, following evaporation, the binding agent is primarily cured by oxidation reactions and polymerization reactions, a process that is induced, for example, by the atmospheric oxygen. The 100% systems contain the constituents of the binding agent without a solvent or water. Said 100% systems are applied to the construction element in such a way that the “drying” of the coating takes place merely by reacting the constituents of the binding agent with each other.

The solvent based systems or water based systems have the disadvantage that the drying times, also called the curing times, are long and, in addition, several layers have to be applied, thus, necessitating several working steps, to achieve the necessary film thickness. Since each individual layer has to be properly dried before the next layer is applied, the result is, on the one hand, a considerable amount of labor in terms of time and correspondingly high costs and a delay in the completion of the building or object, because, depending on climatic conditions, it may take several days before the required layer thickness has been applied. Another drawback is that there is the tendency for coatings that exhibit the required layer thickness to form cracks or to flake off during the drying phase or upon exposure to heat, so that in the worst case the substrate is partially exposed, in particular, in systems, in which the binding agent does not reharden after the solvent or the water has evaporated.

In order to circumvent this drawback, two component systems or multi-component systems based on epoxy/amine have been developed that make do with almost no solvents, so that the curing takes place much more rapidly, and, in addition, thicker layers can be applied in one working step, so that it is possible to build up the required layer thickness much faster. However, these two component systems or multi-component systems have the drawback that the binding agent forms a very stable and rigid polymer matrix, often with a high softening range, a phenomenon that inhibits the formation of foam by the foaming agents. Therefore, thick films have to be applied in order to produce a sufficient foam thickness for the insulation. This aspect in turn is disadvantageous because a lot of material is required. In order for these systems to be applied, processing temperatures of up to +70 deg. C. are often required, a requirement that makes the use of these systems labor intensive and expensive to install.

### BRIEF SUMMARY OF THE INVENTION

Therefore, the object of the present invention is to provide a composition for the formation of an insulating layer for coating systems of the type mentioned in the introductory part in such a way that this insulating layer-forming composition avoids the aforementioned disadvantages and is, in particular, neither solvent based nor water based. Furthermore, it is fast curing, is easy to apply owing to a suitably adapted viscosity and requires only a small layer thickness owing to the high rate of intumescence that can be achieved, i.e. the formation of an effective ash crust layer.

This object is achieved by means of the composition according to patent claim 1. Preferred embodiments are disclosed in the dependent claims.

In one embodiment the insulating layer-forming composition contains (A), an addition-crosslinking polyorganosiloxane, which comprises Si-bonded radicals having aliphatic carbon-carbon multiple bonds; (B), a polyorganosiloxane having Si-bonded hydrogen atoms; (C), a catalyst, which is capable of supporting the reaction between the Si-bonded aliphatic carbon-carbon multiple bond and the Si-bonded hydrogen atoms; and (D), an additive that forms an insulating layer.

The addition-crosslinking polyorganosiloxane (A) can comprise at least three Si-bonded radicals having aliphatic carbon-carbon multiple bonds; and/or the polyorganosiloxane (B) comprises at least three Si-bonded hydrogen atoms.

The content of aliphatic carbon-carbon multiple bonds of the radicals of the addition-crosslinking polyorganosiloxane (A) can be in the range of 0.01 to 3.0 mmol/g.

The content of Si-bonded hydrogen atoms of the polyorganosiloxanes (B) can be in the range of 1.0 to 10.0 mmol/g.

The Si-bonded radicals with aliphatic carbon-carbon multiple bonds can be alkenyl groups. The alkenyl groups can be vinyl groups.

The polyorganosiloxane with Si-bonded radicals can have aliphatic carbon-carbon multiple bonds and/or the polyorganosiloxane can have Si-bonded hydrogen atoms is/are a polydialkylsiloxane. The polydialkylsiloxane can be a polydimethylsiloxane.

The Si-bonded radicals can have carbon-carbon multiple bonds and/or the Si-bonded hydrogen atoms can be terminating or terminating and, in addition, included as side groups along the polysiloxane chain of the polyorganosiloxanes.

The catalyst (C) can be a metal-based catalyst, in which the metal is selected from the group, consisting of rhodium, ruthenium, palladium, osmium, iridium and platinum.

The additive that forms the insulating layer can be a mixture that comprises at least one thermoexpandable compound and/or at least one dehydrogenation catalyst, at least one blowing agent and optionally at least one carbon source. The additive that forms the insulating layer can contain an ash crust stabilizer.

The composition can contain organic and/or inorganic fillers and/or additional additives.

The composition can be formulated as a two or multi-component system.

The constituent (D), which optionally comprises at least one carbon source, at least one blowing agent and at least one dehydrogenation catalyst, can be divided among the components in such a way that these compounds are separated from each other in a reaction inhibiting manner.

The constituent (D) can include an ash crust stabilizer, which may be fully contained in one component or may be divided among all of the components.

The compositions of the invention can be used as a coating. For example, they can be used as for the coating of steel construction elements. As another example, they can be used as the coating of metallic and/or non-metallic substrates. As another example they can be used as a fire protection layer.

Cured objects can be obtained by curing the compositions of the invention.

### BRIEF DESCRIPTION OF SEVERAL VIEWS OF THE DRAWINGS

[Not Applicable]

### DETAILED DESCRIPTION OF THE INVENTION

Based on the aforesaid, the subject matter of the invention is an insulating layer-forming composition containing (A), an addition-crosslinking polyorganosiloxane, which comprises Si bonded radicals having aliphatic carbon carbon multiple bonds; (B), a polyorganosiloxane having Si bonded hydrogen atoms; (C), a catalyst, which is capable of supporting the reaction between the Si bonded aliphatic carbon carbon multiple bond and the Si bonded hydrogen atoms; and (D), an additive that forms an insulating layer.

The composition, according to the invention, allows the coatings comprising a layer thickness, which is required for the respective period of fire resistance, to be applied in a simple and fast manner. In essence, the advantages achieved by means of the invention are that the curing times, which are inherently slow in solvent based systems or water based systems, could be significantly shortened, a feature that significantly reduces the amount of work in terms of time. Due to the low viscosity of the composition in the area of application, where said viscosity is adjusted by means of suitable thickener systems, it is possible, in contrast to epoxy/amine systems, to apply the composition without heating the composition, for example, by the widely established airless spray method.

The inventive composition also makes it possible to achieve a high degree of filling with the fire protection additives by formulating the composition as a two component system or as a multi-component system. As a result, the cost of materials declines, an aspect that has a positive impact on the cost of materials, especially when said system is applied over a large area. This cost cutting is achieved, in particular, through the use of a reactive system that does not physically dry and, therefore, does not suffer from a loss in volume due to the drying off of the solvents or the water in water based systems, but rather cures through polyaddition. Thus, in a classical system a solvent content of about 25% is typical. In the case of the composition according to the invention, more than 95% of the coating remains on the substrate to be protected. Furthermore, the relative stability of the ash crust is very high due to the advantageous structure of the foam that is formed in the event of a fire.

Compared to solvent based systems or water based systems, when they are applied without a primer, the compositions according to the invention show excellent adhesion as well as excellent impact resistance.

For a better understanding of the invention, the following explanations of the terminology used herein are considered to be useful. In the context of the invention:
the term “aliphatic compound” includes acyclic and cyclic, saturated or unsaturated hydrocarbon compounds, which are not aromatic (PAC, 1995, 67, 1307, Glossary of class names of organic compounds and reactivity intermediates based on structure (IUPAC Recommendations 1995));
“chemical intumescence” means the formation of a voluminous, insulating layer of ash by means of matched compounds that react with each other when exposed to heat;
“physical intumescence” means the formation of a voluminous, insulating layer due to the swelling of a compound that, when exposed to heat, releases gases, even though no chemical reaction has taken place between two compounds, as a result of which the volume of the compound increases by a multiple of the original volume;
“insulating layer-forming” means that in the event of a fire a solid microporous carbon foam is produced, so that the fine pored and thick foam layer that is formed (the so called ash crust) insulates, depending on the composition, a substrate against heat;
a “carbon source” means an organic compound that leaves a carbon skeleton due to incomplete combustion and does not burn completely to form carbon dioxide and water (carbonification); these compounds are referred to as “carbon skeleton formers”;
an “acid former” means a compound that, when exposed to heat, i.e., above about 150 deg. C., for example, by decomposition, forms a non volatile acid and, in so doing, acts as a catalyst for the carbonification; in addition, said acid former can contribute to lowering the viscosity of the melt of the binding agent; hence, the term is used interchangeably with the term “dehydrogenation catalyst”;
a “blowing agent” is a compound that decomposes at an elevated temperature while simultaneously developing inert, i.e., non combustible gases, and expands (intumescence) the carbon skeleton, formed by carbonification, and, where appropriate, the softened binding agent to form a foam; this term is used interchangeably with “gas formers”;
an “ash crust stabilizer” is a so called skeleton-forming compound that stabilizes the carbon skeleton (ash crust), which is formed from the interaction of the formation of the carbon from the carbon source and from the gas from the blowing agent or the physical intumescence. In this case the basic mode of action is that the resulting carbon layers, which are really very soft, are mechanically bonded by means of inorganic compounds. The addition of such an ash crust stabilizer contributes to a significant stabilization of the intumescent crust in the event of a fire, because these additives increase the mechanical strength of the intumescent layer and/or prevent this intumescent layer from trickling off, the effect of which is that the insulating effect of the foam is maintained or enhanced.

The addition-crosslinking polyorganosiloxanes that are used are expediently of the kind that cure by means of a transition metal-catalyzed addition reaction, also referred to as hydrosilylation, with polyorganosiloxane crosslinkers, which contain SiH groups.

Therefore, polyorganosiloxanes, which comprise the Si-bonded radicals with aliphatic carbon-carbon multiple bonds, are used as the constituent (A). The carbon-carbon multiple bond may be a carbon-carbon triple bond or a carbon-carbon double bond, with a carbon-carbon double bond being preferred.

Preferably the content of carbon-carbon multiple bonds, in particular, carbon-carbon double bonds, is in the range of 0.01 to 3.0 mmol/g, and even more preferably between 0.05 and 2.5 mmol/g.

In this context the radicals with aliphatic carbon-carbon multiple bonds are terminatingly seated at the polysiloxane chains, so that the polyorganosiloxanes (A) comprise at least two radicals with aliphatic carbon-carbon multiple bonds. Preferably the polyorganosiloxanes comprise addition radicals having aliphatic carbon-carbon multiple bonds as side groups along the polysiloxane chain, so that the polyorganosiloxanes (A) comprise preferably at least three radicals with aliphatic carbon-carbon multiple bonds.

The same also applies to the constituent (B), the polyorganosiloxane crosslinkers, which are expediently polyorganosiloxanes with Si-bonded hydrogen atoms.

If a polyorganosiloxane crosslinker having a functionality of greater than 2, in particular, greater than three or more, is used, then it is also possible to use a polyorganosiloxane comprising only two radicals, which have aliphatic carbon-carbon multiple bonds, and vice versa.

According to one embodiment, the polyorganosiloxanes, which comprise Si bonded radicals with aliphatic carbon carbon multiple bonds, have the structure (I)

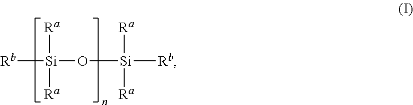

where each Ra represents, independently of each other, an alkyl group; each Rb represents, independently of each other, an alkenyl or alkynyl group; and n is selected in such a way that the viscosity of the compound is about 30 to 200,000 mPa·s, preferably 40 to 100,000 mPa·s, and even more preferably 100 to 10,000 mPa·s at 25 deg. C., or structure (II)

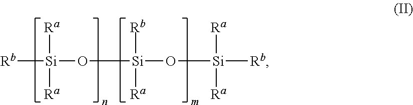

where each Ra and Rb is defined as for structure (I); and n and m are selected in such a way that the content of carbon carbon multiple bonds, in particular, carbon carbon double bonds, is in the range of 0.01 to 3.0 mmol/g; and the viscosity of the compound is about 100 to 4,000 mPa·s, preferably 120 to 3,000 mPa·s, and even more preferably 200 to 1,500 mPa·s at 25 deg. C.

Mixtures of polyorganosiloxanes of structure (I) and polyorganosiloxanes of structure (II) may also be used as the addition crosslinking polyorganosiloxanes.

The alkyl group is preferably a C1 C18 alkyl group, even more preferably a C1-C8 alkyl group, and even more preferably a methyl or ethyl group, with a methyl group being the most highly preferred.

The alkenyl group is preferably a C2 C8 alkenyl group, more preferably a C2 C4 alkenyl group, even more preferably a vinyl group, an allyl group or a hexenyl group, with a vinyl group being the most highly preferred.

The alkynyl group is preferably a C2 C8 alkynyl group, more preferably a C2 C4 alkynyl group, such as ethyne, 1 propyne and 1 butyne.

Particularly preferred are compounds of the structures (I) and (II), where each Ra is a methyl group, and each Rb is a vinyl group.

The polyorganosiloxane crosslinker is, according to the invention, a polyorganosiloxane having Si bonded hydrogen atoms. In this case the hydrogen atoms sit in a more or less terminating manner. Preferably additional Si bonded hydrogen atoms are included in the polysiloxane chain.

Preferably, the content of Si bonded hydrogen atoms is in the range of 1.0 to 10.0 mmol/g and more preferably between 2.0 to 8.0 mmol/g.

The polyorganosiloxanes, which comprise Si bonded hydrogen atoms, have preferably the structure (Ill)

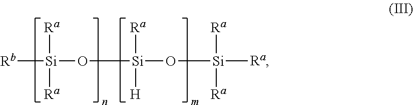

or the structure (IV)

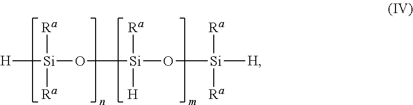

where Ra is defined as above for the structures (I) and (II); and n and m are selected in such a way that the content of Si-bonded hydrogen atoms is in the range of 1.0 to 10.0 mmol/g; and the viscosity of the compound is about 30 to 600 mPa·s, preferably 40 to 500 mPa·s, and even more preferably 45 to 100 mPa·s at 25 deg. C. Mixtures of polyorganosiloxanes of the structure (III) and polyorganosiloxanes of the structure (IV) can also be used as crosslinkers.

In order for the hydrosilylation reaction to run sufficiently fast and for the composition to be provided as a cold curing composition, it is necessary that a catalyst, constituent (C), be used.

It is expedient for the catalyst to be a compound that is capable of supporting the reaction between the aliphatic carbon carbon multiple bond and the Si H bond of the crosslinker.

Suitable catalysts include metal based catalysts with metals of the platinum group, such as catalysts that contain rhodium, ruthenium, palladium, osmium, iridium or platinum. Platinum based catalysts are particularly preferred. They may be present in any of the known forms, for example, platinum (0), such as, platinum deposited on activated carbon, platinum chloride, platinum salts, chloroplatinic acid(s) and encapsulated forms thereof.

The catalyst is made preferably from dilute solutions of highly reactive platinum complexes. The complexes are dissolved in the vinyl functional polydimethylsiloxanes or in divinyltetramethyldisiloxane (DE 1262271 B) or in methylvinylcyclosiloxane. It is more preferred that the catalyst be made from a divinyltetramethyldisiloxane platinum (0) complex or a methylvinylcyclosiloxane platinum (0) complex, such as, for example, the dinuclear reaction product of 1,1,3,3 tetramethyl 1,3 divinyldisiloxane with hexachloroplatinic acid in isopropanol (“Karstedt catalyst”) is mentioned as an example.

The vinyl content of the solutions is 0.10 to 12.0 mmol/g; the platinum content is 500 to 20,000 ppm.

Particularly preferred catalysts include the divinyltetramethyldisiloxane platinum (0) complex and the methylvinylcyclosiloxane platinum (0) complex, dissolved in either divinyltetramethyldisiloxane or methylvinylcyclosiloxane.

According to the invention, the constituent (D) contains an additive that forms an insulating layer, where in this case the additive may include both single compounds as well as a mixture of several compounds.

The additives that are used to form an insulating layer are expediently of the kind that form, when exposed to heat, an expanding, insulating layer from a flame protection material. This layer protects the substrate from overheating and, thus, prevents or at least slows down the change that occurs in the construction elements, bearing the mechanical and static properties, and that are caused by exposure to heat. The formation of a voluminous, insulating layer, i.e., an ash layer, may be formed by the chemical reaction of a mixture of compounds that are appropriately adjusted to one another and that react with each other when exposed to heat. Such systems are known to those skilled in the art by the term chemical intumescence and may be used in accordance with the present invention. As an alternative, the voluminous, insulating layer may be formed by expanding a single compound, which releases gases when exposed to heat, without a chemical reaction between two compounds having taken place. Such systems are known to those skilled in the art by the term physical intumescence and may also be used in accordance with the present invention. Each of these systems may be used, according to the invention, alone or together as a combination.

In order to form an intumescent layer by chemical intumescence, at least three constituents are generally required: a carbon source, a dehydrogenation catalyst and a blowing agent; and in the case of coatings, for example, these three constituents are included in a binding agent. When exposed to heat, the binding agent softens, and the fire protection additives are released, so that in the case of chemical intumescence they are able to react with each other or in the case of physical intumescence they are able to expand. The acid, which is used as a catalyst for carbonification of the carbon source, is formed from the dehydrogenation catalyst by thermal decomposition. At the same time the blowing agent thermally decomposes to form inert gases, the effect of which is that the carbonized (charred) material and optionally the softened binding agent expand and, in so doing, form a voluminous insulating foam.

In one embodiment of the invention, in which the insulating layer is formed by chemical intumescence, the additive that forms an insulating layer comprises at least one carbon skeleton former and, if the binding agent cannot be used as such, then at least one acid former, at least one blowing agent, and at least one inorganic skeleton former. The components of the additive are selected in such a special way that they are able to develop a synergism, with some of the compounds being able to fulfill a plurality of functions.

The carbon source that may be considered includes the compounds that are commonly used in intumescent fire protection formulations and are known to those skilled in the art, such as starch like compounds, for example, starch and modified starch, and/or polyhydric alcohols (polyols), such as oligosaccharides and polysaccharides and/or a thermoplastic or duroplastic polymeric resin binding agent, such as a phenolic resin, a urea resin, a polyurethane, polyvinyl chloride, poly (meth)acrylate, polyvinyl acetate, polyvinyl alcohol, a silicone resin and/or a rubber. Suitable polyols are polyols selected from the group sugar, pentaerythritol, dipentaerythritol, tripentaerythritol, polyvinyl acetate, polyvinyl alcohol, sorbitol, polyoxyethylene/polyoxypropylene (EO PO) polyols. Pentaerythritol, dipentaerythritol or polyvinyl acetate is preferably used.

It should be mentioned that in the event of a fire the binding agent itself may also have the function of a carbon source.

The dehydrogenation catalysts or more specifically the acid formers that may be considered include the compounds that are commonly used in intumescent fire protection formulations and are known to those skilled in the art, such as a salt or an ester of an inorganic, non volatile acid selected from sulfuric acid, phosphoric acid or boric acid. In essence, phosphorus containing compounds are used. The range of these phosphorus containing compounds is very wide, since they extend over several oxidation stages of the phosphorus, such as phosphines, phosphine oxides, phosphonium compounds, phosphates, elemental red phosphorus, phosphites and phosphates. Some examples of the phosphoric acid compounds that may be mentioned include: monoammonium phosphate, diammonium phosphate, ammonium phosphate, ammonium polyphosphate, melamine phosphate, melamine resin phosphate, potassium phosphate, polyol phosphate, such as, for example, pentaerythritol phosphate, glycerol phosphate, sorbitol phosphate, mannitol phosphate, dulcite phosphate, neopentyl glycol phosphate, ethylene glycol phosphate, dipentaerythritol phosphate and the like. A polyphosphate or an ammonium polyphosphate is used preferably as the phosphoric acid compound. In this case the term melamine resin phosphates is understood to mean compounds, such as reaction products of Lamelite C (melamine formaldehyde resin) with phosphoric acid. Some examples of sulfuric acid compounds that may be mentioned include: ammonium sulfate, ammonium sulfamate, nitroaniline bisulfate, 4 nitroaniline 2 sulfonic acid and 4,4 dinitrosulfanilamide and the like. Melamine borate may be mentioned as an example for the boric acid compound.

The blowing agents that may be considered include the compounds that are commonly used in fire protection formulations and are known to those skilled in the art, such as cyanuric acid or isocyanic acid and derivatives thereof, melamine and derivatives thereof. Such are: cyanamide, dicyanamide, dicyandiamide, guanidine and the salts thereof, biguanide, melamine cyanurate, cyanic acid salts, cyanic acid esters and cyanic acid amides, hexamethoxymethylmelamine, dimelamine pyrophosphate, melamine polyphosphate, melamine phosphate. Preferably hexamethoxymethyl melamine or melamine (cyanuric acid amide) is used.

Furthermore, suitable components are of the kind that do not limit their mode of action to a single function, such as melamine polyphosphate, which acts both as an acid former and as a blowing agent. Additional examples are described in GB 2 007 689 A1, EP 139 401 A1 and U.S. Pat. No. 3,969,291 A1.

In one embodiment of the invention, in which the insulating layer is formed not only by chemical intumescent, but also by physical intumescence, the additive that forms the insulating layer also includes at least one thermoexpandable compound, such as a graphite intercalation compound, which is also known as an exfoliated graphite, which can also be incorporated into the binding agent.

Suitable exfoliated graphites that may be considered include, for example, known intercalation compounds of SOx, NOx, halogen and/or strong acids in graphite. They are also referred to as graphite salts. Preferred are the exfoliated graphites that emit SO2, SO3, NO and/or NO2 at temperatures of, for example, 120 to 350 deg. C. during expansion. The exfoliated graphite may be present, for example, in the form of platelets having a maximum diameter in the range of 0.1 to 5 mm. Preferably this diameter is in the range of 0.5 to 3 mm. For the present invention suitable exfoliated graphites are commercially available. In general, the exfoliated graphite particles are uniformly distributed in the composition of the invention. However, the concentration of exfoliated graphite particles may also vary in the form of points or a pattern, as a flat area and/or a sandwich. In this respect reference is made to EP 1489136 A1, the content of which is hereby incorporated by reference in this patent application.

Since the ash crust that is formed in the event of a fire is too unstable in most cases and, therefore, as a function of its density and structure, can be blown about, for example, by air currents, an aspect that has an adverse effect on the insulating effect of the coating, at least one ash crust stabilizer may be added to the components just listed.

Some examples of the ash crust stabilizers or more specifically the skeleton formers that may be considered include the compounds that are commonly used in fire protection formulations and are known to those skilled in the art, for example, exfoliated graphite and particulate metals, such as aluminum, magnesium, iron and zinc. The particulate metal may be in the form of a powder, platelets, scales, fibers, filaments and/or whiskers, where in this case the particulate metal in the form of powder, platelets or scales has a particle size of ≦50 μm, preferably from 0.5 to 10 μm. In the event that the particulate metal is used in the form of fibers, filaments and/or whiskers, a thickness of 0.5 to 10 μm and a length of 10 to 50 μm are preferred. As an alternative or in addition, it is possible to use, as the ash crust stabilizer, an oxide or a compound of a metal from the group comprising aluminum, magnesium, iron or zinc, in particular, an iron oxide, preferably ferric trioxide, titanium dioxide, a borate, such as zinc borate and/or a glass frit made of low melting glasses having a melting temperature of preferably at or above 400 deg. C., phosphate glasses or sulfate glasses, melamine polyzinc sulfates, ferro glasses or calcium borosilicates. The addition of such an ash crust stabilizer contributes to a significant stabilization of the ash crust in the event of a fire, since these additives enhance the mechanical strength of the intumescent layer and/or prevent said layer from trickling off. Examples of such additives may also be found in U.S. Pat. No. 4,442,157 A, U.S. Pat. No. 3,562,197 A, GB 755 551 A as well as EP 138 546 A1.

In addition, such ash crust stabilizers as melamine phosphate or melamine borate may be included.

Optionally one or more reactive flame retardants may be added to the composition of the invention. Such compounds are incorporated into the binding agent. One example in the context of the invention includes the reactive organophosphorus compounds, such as 9,10 dihydro 9 oxa 10 phosphaphenanthrene 10 oxide (DOPO) and derivatives thereof, such as, for example, DOPO HQ, DOPO NQ, and adducts. Such compounds are described, for example, by S. V. Levchik, E. D. Weil in Polym. Int. 2004, vol. 53, pp. 1901-1929 or by E. D. Weil, S. V. Levchik (ed.) in Flame Retardants for Plastic and Textiles—Practical Applications, Hanser, 2009.

The additive that forms the insulating layer may be present in an amount of 30 to 99% by wt. in the composition, where in this case the amount depends more or less on the form of the application of the composition (spraying, brushing and the like). In order to bring about the highest possible rate of intumescence, the content of constituent D is set as high as possible in the total formulation. Preferably the content of the constituent D in the total formulation is 35 to 85% by wt. and more preferably 40 to 85% by wt.

In addition to the additives that form an insulating layer, the composition may contain, if desired, organic and/or inorganic adjuvants and/or other additives. Such adjuvants and additives are usually auxiliary agents, such as solvents, for example, xylene or toluene, wetting agents, for example, based on polyacrylates and/or polyphosphates, defoamers, such as silicone defoamers, thickeners, such as alginate thickeners, dyes, fungicides, plasticizers, such as chlorinated waxes, binding agents, flame retardants or various fillers, such as vermiculite, inorganic fibers, silica sand, glass micro beads, mica, silicon dioxide, mineral wool, and the like.

Additional additives, such as thickeners, rheological additives and fillers, may also be added to the composition. Preferably polyhydroxycarboxylic acid amides, urea derivatives, salts of unsaturated carboxylic esters, alkylammonium salts of acidic phosphoric acid derivatives, ketoximes, amine salts of p toluene sulfonic acid, amine salts of sulphonic acid derivatives and aqueous or organic solutions or mixtures of the compounds are used as the rheological additives, such as anti settling agents, anti sag agents and thixotropic agents. In addition, it is possible to use rheological additives based on pyrogenic or precipitated silicic acids or based on silanized pyrogenic or precipitated silicic acids. Preferably the rheological additives are pyrogenic silicic acids, modified and unmodified phyllosilicates, precipitated silicic acids, cellulose ethers, polysaccharides, polyurethane thickeners and acrylic thickeners, urea derivatives, castor oil derivatives, polyamides and fatty acid amides and polyolefins, unless they are in solid form, powdered cellulose and/or suspending agents, such as, for example, xanthan gum.

The inventive composition may be formulated as a two component system or a multi-component system.

Since the constituent (A) and the constituent (B) do not generally react with each other at room temperature, both constituents can be stored together. The catalyst may be stored either separately from the constituents (A) and (B), or said catalyst may be included in one of these constituents or may be divided between both constituents. This approach makes it possible to achieve the objective that the two compounds (A) and (B) of the binding agent are not mixed together until immediately prior to use and initiate the curing reaction. This feature makes the system easier to use.

In this case the constituent (D) may be present as a total mixture or divided into individual components in a first component I and/or a second component II. The distribution of the constituent (D) is carried out, as a function of the compatibility of the compounds present in the composition, so that neither a reaction of the compounds present in the composition with one another or a mutual interference nor a reaction of these compounds with the compounds of the other constituents can take place. This arrangement depends on the compounds that are used. This approach ensures that the highest possible proportion of fillers can be achieved. The net result is a high intumescence, even if the coating thicknesses of the composition is small.

In one embodiment the constituent (D), which optionally comprises at least one carbon source, at least one blowing agent and at least one dehydrogenation catalyst, is divided in such a manner among the components that these compounds are separated from each other in a reaction inhibiting manner.

Furthermore, in an additional embodiment the constituent D includes an ash crust stabilizer, which is divided among the components in such a way that each component comprises at least a portion of the ash crust stabilizer.

The composition is applied as a paste with a brush, a roller or by spraying onto the substrate, in particular, a metallic substrate. Preferably the composition is applied by means of an airless spray method.

Compared to the solvent based systems and water based systems, the composition of the invention is characterized by a relatively fast curing as a result of an addition reaction (or more specifically by a catalyst-supported hydrosilylation reaction) and, thus, by unnecessary drying. This aspect is very important, especially if the coated construction elements have to be quickly stressed or further processed, whether as a result of coating with a cover layer or as a result of moving or transporting the construction elements. The effect is that the coating is much less susceptible to external influences at the construction site, such as, for example, exposure to (rain) water or dust and dirt, which may result in the leaching out of the water soluble constituents, such as ammonium polyphosphate, in solvent based systems or water based systems; or in the case of dust accumulation it may result in a reduced intumescence. Owing to the low viscosity of the composition despite the high solids content, the composition remains easy to process, in particular, by means of a continuous spraying process.

Therefore, the composition according to the invention lends itself well as a coating, in particular, as a fire protection coating, preferably a sprayable coating for metal based substrates and non metal based substrates. The substrates are not limited and include construction elements, in particular, steel constructions and wood constructions, as well as individual cables, bundles of cables, cable trays and cable ducts or other conduits.

The composition, according to the invention, is used predominately in the construction industry as a coating, in particular, as a fire protection coating for steel construction elements as well as for construction elements made of other materials, such as concrete or wood, as well as a fire protection coating for single cables, bundles of cables, cable trays and cable ducts or other conduits.

Therefore, an additional subject matter of the invention is the use of the inventive composition as a coating, in particular, as a coating for construction elements or construction elements made of steel, concrete, wood and other materials, such as, for example, synthetic plastic materials, in particular, as a fire protection coating.

The present invention also relates to objects that are obtained when the inventive composition is cured. The objects have excellent insulating layer-forming properties.

The following examples serve to further illustrate the invention.

### Exemplary Embodiments

In order to prepare the inventive compositions for the formation of an insulating layer, the individual components are mixed and homogenized, as specified below, with the aid of a dissolver.

In each case the curing behavior was monitored; then the intumescent factor and the relative ash crust stability were determined. For this purpose each of the compositions was placed in a round Teflon mold having a depth of about 2 mm and a diameter of 48 mm.

In this context the time for the curing corresponds to the time, after which the samples were completely cured and could be removed from the Teflon mold.

In order to determine the intumescent factor and the relative ash crust stability, a muffle furnace was preheated to 600 deg. C. Multiple measurements of the sample thickness were carried out with the caliper; and the mean value h_{M} was calculated. Then each sample was placed in a cylindrical steel mold and heated for 30 minutes in a muffle furnace. After cooling to room temperature, the foam height h_{E1} was first determined in a non-destructive manner (mean value of multiple measurements). The intumescent factor I is calculated as follows:

intumescent factor I: I=h_{E1}:h_{M}

Then a defined weight (m=105 g) was allowed to fall from a defined height (h=100 mm) onto the foam in the cylindrical steel mold; and then the foam height h_{E2} that remained after this partially destructive action was determined. The relative ash crust stability was calculated as follows:

relative ash crust stability (AKS): AKS=h_{E2}:h_{E1}

The following composition was used as the constituent D in the examples below:

Constituent D:

| Constituent | Quantity [g] |
|---|---|
| pentaerythritol | 8.7 |
| melamine | 8.7 |
| ammonium polyphosphate | 16.6 |
| titanium dioxide | 7.9 |

### Reference Example 1

A commercial fire protection product (Hilti CFP S WB), which is based on an aqueous dispersion technology, was used as the reference.

### Reference Example 2

An additional reference that was used included a standard epoxy amine system (Jeffamin® T 403, liquid, solvent free and crystallization stable epoxy resin, consisting of low molecular weight epoxy resins based on bisphenol A and bisphenol F (Epilox® AF 18 30, Leuna-Harze GmbH) and 1,6 hexanediol diglycidyl ether), which was tested, filled to 60% with an intumescent mixture in a manner analogous to the above examples.

### Reference Example 3

Another reference that was used included a standard epoxy amine system (isophorone diamine, trimethylolpropane triacrylate and liquid, solvent-free and crystallization stable epoxy resin, consisting of low molecular weight epoxy resins based on bisphenol A and bisphenol F (Epilox® AF 18-30, Leuna-Harze GmbH), which was tested, filled to 60% with an intumescent mixture in a manner analogous to the above examples.

### Example 1

Constituents A and C

| Compounds | Quantity [g] |
|---|---|
| Polymer XP RV 200 ^{a)} | 5.9 |
| Catalyst 500 ^{b)} | 0.2 |

^{a)} vinyl functional polydimethylsiloxanes; hanse chemie AG (viscosity at 25 deg. C. 360 mPa · s, vinyl content 2.3 mmol/g)
^{b)} catalysts for addition-crosslinking silicone polymers; hanse chemie AG (viscosity at 25 deg. C. 360 mPa · s, vinyl content 2.3 mmol/g)

Constituent B

| Compounds | Quantity [g] |
|---|---|
| Crosslinker 100 ^{c)} | 4.6 |

^{c)} crosslinker for vinyl functional silicone polymers; hanse chemie AG (viscosity at 25 deg. C. mPa · s, SiH content mmol/g)

Constituent D

| Compounds | Quantity [g] |
|---|---|
| as specified above | 14.1 |

It is very clear from the results shown in Table 1 that the inventive compositions cure faster than the reference composition.

TABLE 1
Results of the measurements of the curing time

| | Sample thickness h_{A} | |
|---|---|---|
| Example | (mm) | Curing time |
| Example 1 | 3 | 24 hours |
| Reference example 1 | 2 | 10 days |

TABLE 2
Results of the measurements of the intumescent
factor and the ash crust stability

| | | Relative ash crust | Sample |
|---|---|---|---|
| | Intumescent factor 1 | stability AKS | thickness h_{M} |
| Example | (multiple) | (multiple) | (mm) |
| Example 1 | 2 | 0.70 | 3.0 |
| Reference | 22 | 0.04 | 1.6 |
| example 2 | | | |
| Reference | 1.7 | 0.60 | 1.2 |
| example 3 | | | |

1. Insulating layer-forming composition comprising
an addition-crosslinking polyorganosiloxane having Si-bonded radicals with aliphatic carbon-carbon multiple bonds;
a polyorganosiloxane having Si-bonded hydrogen atoms;
a catalyst; and
an additive that forms an insulating layer.

2. An insulating layer-forming composition of claim 1 wherein the addition-crosslinking polyorganosiloxane has at least three Si-bonded radicals having aliphatic carbon-carbon multiple bonds; and/or the polyorganosiloxane has at least three Si-bonded hydrogen atoms.

3. An insulating layer-forming composition of claim 1 wherein the content of aliphatic carbon-carbon multiple bonds of the radicals of the addition-crosslinking polyorganosiloxane is in the range of 0.01 to 3.0 mmol/g.

4. An insulating layer-forming composition of claim 1 wherein the content of Si-bonded hydrogen atoms of the polyorganosiloxanes is in the range of 1.0 to 10.0 mmol/g.

5. An insulating layer-forming composition of claim 1 wherein the Si-bonded radicals with aliphatic carbon-carbon multiple bonds are alkenyl groups.

6. An insulating layer-forming composition of claim 5 wherein the alkenyl groups are vinyl groups.

7. An insulating layer-forming composition of claim 1 wherein the polyorganosiloxane with Si-bonded radicals having aliphatic carbon-carbon multiple bonds and/or the polyorganosiloxane having Si-bonded hydrogen atoms is/are a polydialkylsiloxane.

8. An insulating layer-forming composition of claim 7 wherein the polydialkylsiloxane is a polydimethylsiloxane.

9. An insulating layer-forming composition of claim 1 wherein the Si-bonded radicals having carbon-carbon multiple bonds and/or the Si-bonded hydrogen atoms are terminating or terminating and, in addition, are included as side groups along the polysiloxane chain of the polyorganosiloxanes.

10. An insulating layer-forming composition of claim 1 wherein the catalyst is a metal-based catalyst, in which the metal is selected from the group, consisting of rhodium, ruthenium, palladium, osmium, iridium and platinum.

11. An insulating layer-forming composition of claim 1 wherein the additive that forms the insulating layer is a mixture that comprises at least one thermoexpandable compound and/or at least one dehydrogenation catalyst, at least one blowing agent and optionally at least one carbon source.

12. An insulating layer-forming composition of claim 11 wherein the additive that forms the insulating layer contains an ash crust stabilizer.

13. An insulating layer-forming composition of claim 1 further comprising organic and/or inorganic fillers and/or additional additives.

14. An insulating layer-forming composition of claim 1 which is formulated as a two or multi-component system.

15. An insulating layer-forming composition of claim 14 wherein the additive that forms an insulating layer is divided among the components in such a way that these compounds are separated from each other in a reaction inhibiting manner.

16. An insulating layer-forming composition of claim 15 wherein, the additive that forms an insulating layer includes an ash crust stabilizer, which may be fully contained in one component or may be divided among all of the components.

17. Use of an insulating layer-forming composition comprising:
providing an insulating layer-forming composition comprising
an addition-crosslinking polyorganosiloxane having Si bonded radicals with aliphatic carbon carbon multiple bonds,
a polyorganosiloxane having Si bonded hydrogen atoms,
a catalyst, and
an additive that forms an insulating layer;
providing a substrate; and
coating the insulating layer-forming composition onto the substrate.

18. Use of an insulating layer-forming composition of claim 17 wherein the substrate is a steel construction element.

19. Use of an insulating layer-forming composition of claim 17 wherein the substrate is a metallic and/or non-metallic substrate.

20. Use of an insulating layer-forming composition of claim 17 wherein the insulating layer-forming composition is a fire protection layer.

21. A cured object comprising:
an insulating layer-forming composition comprising
an addition-crosslinking polyorganosiloxane having Si bonded radicals with aliphatic carbon carbon multiple bonds;
a polyorganosiloxane having Si bonded hydrogen atoms;
a catalyst; and
an additive that forms an insulating layer
wherein the insulating layer-forming composition is cured.
